(19) United States
(12) Patent Application Publication
(10) Pub. No.: US 2014/0316066 A1
(43) Pub. Date: Oct. 23, 2014

(54) Method and System for Producing Polyester

(71) Applicant: Hitachi, Ltd., Tokyo (JP)

(72) Inventors: Masayuki KAMIKAWA, Tokyo (JP); Takeyuki KONDO, Tokyo (JP); Kenichiro OKA, Tokyo (JP); Toshiaki MATSUO, Tokyo (JP); Yasunari SASE, Tokyo (JP)

(73) Assignee: Hitachi, Ltd., Tokyo (JP)

(21) Appl. No.: 14/252,988

(22) Filed: Apr. 15, 2014

(30) Foreign Application Priority Data
Apr. 22, 2013 (JP) 2013-089733

(51) Int. Cl. C08G 63/78; B01J 19/00

(52) U.S. Cl. CPC C08G 63/785; B01J 19/00
USPC 525/53; 422/134

(57) ABSTRACT

Provided are a polyester production apparatus and a method, which can rapidly exhaust water produced by the dehydration condensation reaction, from the reaction system.

The polyester production apparatus includes:
an esterification reactor producing polymer by the dehydration condensation reaction between 1,3-propanediol and dicarboxylic acid to volatilize a volatile component including eliminated water produced in said dehydration condensation reaction,
a plurality of polymerization reactors increasing the polymerization degree by carrying out polycondensation reaction between polymers, and to volatilize the volatile component including the eliminated product generated by said polycondensation reaction,
a wet-type condenser condensing said eliminated water and exhausting the condensed component and non-condensed component, and
a decompression apparatus reducing a pressure in said esterification reactor.

Said volatile component's outlet of said esterification reactor is connected to the volatile component's inlet of said wet-type condenser, and said decompression apparatus is connected next to the non-condensed component's outlet of said wet-type condenser.

### BACKGROUND OF THE INVENTION

1. Field of the Invention

The present invention relates to a production method and a production apparatus of polyester.

Polytrimethylene terephthalate, which has an excellent property of a synthesized fiber material, is the polyester, produced via polymerization between 1,3-propanediol and terephthalic acid. As a method for industrially producing polytrimethylene terephthalate, a continuously synthesizing method by using a melt polycondensation method is known.

This method includes the step of: continuously feeding raw material of 1,3-propanediol and terephthalic acid with a catalyst carry out dehydration condensation reaction, by which a lowly polymerized oligomer with hydroxyl radicals at the terminals of oligomer chain is provided.

Then, let the produced oligomers react each other at a high temperature under low pressure without using a solvent in the polycondensation reaction, which provides polyester. Further continuity of the polycondensation reaction of the oligomer lets finally polytrimethylene terephthalate with molecular weight about 20,000 and adequate for fiber use to be produced at the end of the process.

Dehydration condensation reaction and polycondensation reaction which produce a polymer, are equilibrium reactions, therefore, so as to make the polymerization efficient, an eliminated component must be volatilized to be removed from the reaction system.

2. Description of the Related Art

In view of those requirements, Patent Document 1 discloses continuous polymerization of a dihydroxyester of a difunctional carboxlic acid or polymerizable low molecular weight oligomer of them with a polyester polymerizing catalyst under the atmospheric pressure to obtain higher polymerization degree production and suggests the method to eliminate by-products from such a system by using inert gas.

### PRIOR ART DOCUMENT

### Patent Document

Patent Document 1: JP3287572 (B)

Polyester production has the problems that continuation of the reaction is obstacled by water, because a dehydration reaction is an equilibrium reaction, if the water, which is produced by a glycol and a dicarboxylic acid, remains in the reaction system, and that harmful pyrolysate is produced, and that quality of produced polyester is deteriorated. Further the water, which produced in the dehydration condensation reaction, could contact and deactivate the catalyst and therefore catalyst had to be added again in the subsequent polycondensation reaction. If amount of catalyst increased because of additional catalyst, produced polyester deteriorated heat stability and pin holes appeared on the film when a polyester thin film was produced. Therefore means was needed to remove quickly the water, which was produced by the dehydration condensation, from the reaction system.

However, if polyester continuously producing apparatus under reduced pressure by melt polymerization tries using inert gas like Patent Document 1, then enormous costs will be necessary to adjust the reaction condition of high temperature and reduced pressure. In addition to that, production efficiency might become lower.

Therefore an aim of the present invention is, concerning continuous polyester producing apparatus and method by the melt polymerization under a low pressure, the polyester producing apparatus and method, which remove water produced by dehydration condensation reaction, quickly from the reaction system.

### SUMMARY OF THE INVENTION

The present invention has solved the problem and is comprised of
an esterification reactor, which makes the dehydration reaction of 1,3-propanedioland and a dicarboxylic acid, and volatilizes eliminated water in the reaction of the said dehydration condensation;
a plurality of polymerizing reactors which make polymerization degree higher by polycondensation reaction of polymers, and which volatilizes volatile component including an eliminated product produced in the said polycondensation reaction;
a wet-type condenser, which condenses the eliminated water and discharges both of condensed component and non-condensed component;
decompression apparatus, which makes pressure in esterification reactor low.

The present invention is characterized by;
an outlet of said esterification reactor being connected to an inlet of said wet-type condenser;
and a non-volatile component's outlet of said wet-type condenser being connected to said decompression apparatus.

The present invention provides the polyester production apparatus and method, which can quickly remove the water generated by the dehydration condensation reaction.

### BRIEF DESCRIPTION OF THE DRAWINGS

FIG. 1 is a block drawing showing a production apparatus according to an embodiment of the present invention.

FIGS. 2A, 2B and 2C are schematic drawings showing three forms of the wet-type condenser.

FIG. 3 is a block drawing showing a production apparatus according to the first variation.

FIG. 4 is a block drawing showing a production apparatus according to the second variation.

FIG. 5 is a block drawing showing a production apparatus according to the third variation.

### DETAILED DESCRIPTION OF THE PRESENT INVENTION

An embodiment of the polyester production apparatus and the method of the present invention shall be explained below with reference to the drawings.

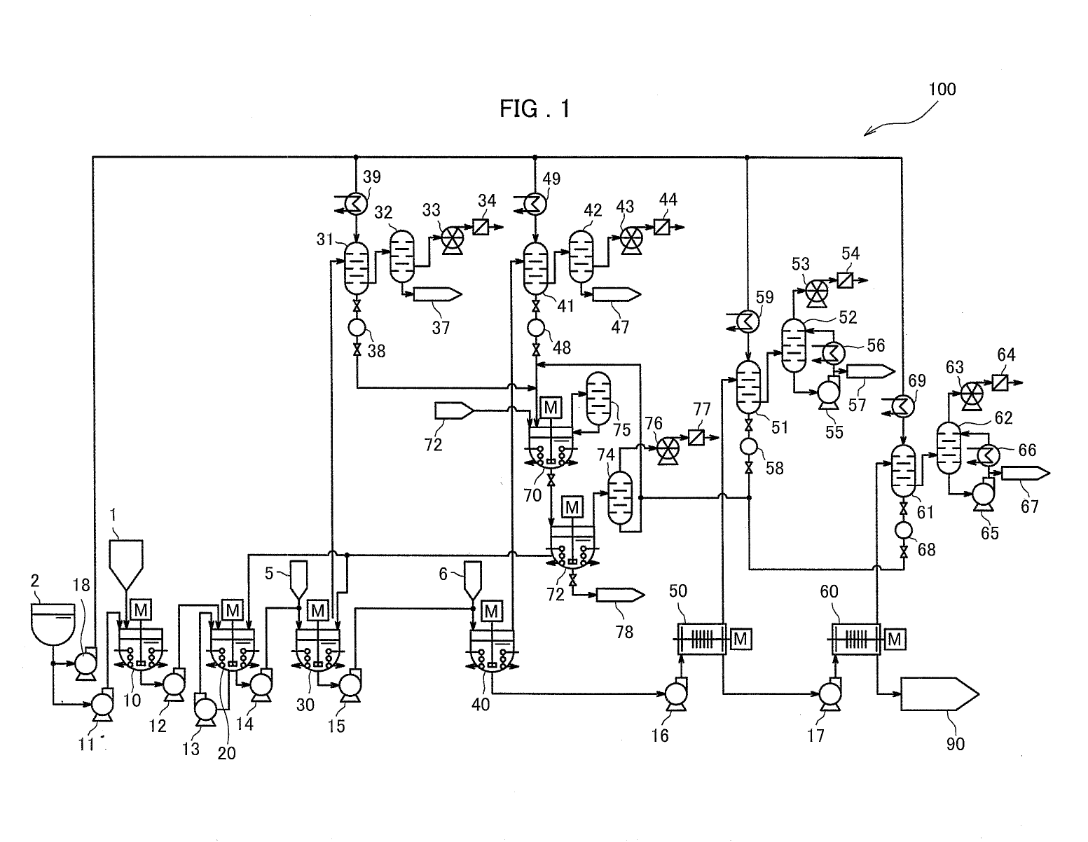

FIG. 1 is a block drawing showing a production apparatus according to an embodiment of the present invention.

A polyester production apparatus 100 of the present embodiment produces polytrimethlene terephthalate from 1,3-propanediol of glycol and terephtalic acid of dicarboxylic acid as raw materials.

The production method executed by the production apparatus of the present embodiment is a method of continuous polyester synthesis by a melt polycondensation method, which is comprised of

An esterification process, in which continuously supplying raw materials 1,3-propanediol and terephthalic acid react, in dehydration condensation reaction, under reduced atmosphere with a catalyst to produce a low polymerization degree of oligomer with an hydroxyl radical at the molecule terminal; and

A polycondensation process, in which polyesters react with each others to enlarge the polymerization degree by the polycondensation reaction under the following condition, at high temperature and under reduced pressure without any solvent.

The polycondensation process includes a step, in which polyester with relatively low polymerization degree can be obtained by the polycondensation reaction of oligomers obtained in the esterification process, and includes a plurality of the steps, in which polyester with higher polymerization degree can be obtained by the polycondensation reaction of the obtained polyester with relatively low polymerization degrees each other. In the production apparatus of the present embodiment, if such a step-wise polymerization is carried out in the reactors, of which pressures are controlled so that degrees of vacuum become higher as the step becomes subsequent stage. As a result, polytrimethylene terephthalate for fiber use with the increased molecular weight to about 20,000 can be produced continuously.

The polyester production apparatus 100 of the present embodiment is comprised, as shown in FIG. 1, of connected in series, mainly raw material feeders like 1, 2, raw material mixer 10, raw material tank 20, esterification reactor 30, first polymerization reactor 40, intermediate polymerization reactor 50, last polymerization reactor 60.

Each of reactors equipped with the reaction system carries out the condensation reaction (the dehydration condensation reaction or the polycondensation reaction) of equilibrium and the volatilization of eliminated component is done to promote each reaction.

The production apparatus of the present embodiment, especially, esterification reactor 30, in which esterification takes place, is operated under reduced pressure lower than normal pressure to volatilize the water generated in the dehydration condensation reaction and to make the effect of the water remaining in the reaction system lower.

The number of reactors is not limited to 3 reactors, but depending on the polymerization degree of the polyester as product. For example, the polymerization reactors can consist of 2 reactors, i.e., the first polymerization reactor and the last polymerization reactor. Or the polymerization reactors can consist of more than 4 reactors.

Each of reactors 30, 40, 50, 60 equipped to reaction system is connected to each of independent exhaust systems.

The exhaust systems has functions to collect or dispose volatile component volatilized in the reactors. The exhaust systems contribute to the forming of pressure condition in reactors as well, and consist mainly of condensers 31, 32, 41, 42, 51, 52, 61, 62, decompression apparatus 33, 43, 53, 63 and detoxifying apparatus 34, 44, 54, 64.

The production apparatus of the present embodiment carries out the esterification process under the reduced pressure atmosphere. So esterification reactor 30 exhausts more volatile component than carrying out under the normal pressure. Therefore the outlet of volatile component of esterification reactor 30 is connected to a wet-type condenser, which is a component of exhaust system.

The components of the production apparatus of the present embodiment are explained referring FIG. 1.

The raw material feeding apparatus 1, 2 are apparatus, which feed raw materials of polyester, i.e. 1,3-propanediol as a glycol and terephthalic acid as a dicarboxylic acid, into reaction system.

The raw material feeding apparatus 1 consists of a powder feeder etc., which feeds terephthalic acid of powder solid. The raw material feeding apparatus 2 consists of a storage tank, which feeds 1,3-propanediol of relatively low viscous liquid.

The ratio of 1,3-propanediol and terephthalic acid as feeding raw materials can be controlled suitably concerning the polymerization degree of producing polytrimethlene terephthalate. However, in the esterification process, which is described later, 1,3-propanediol and terephthalic acid can carry out a cycling reaction and provide cyclic esters without reactive functional radicals. Therefore to 1 molar terephthalic acid, it is preferable to feed 1.02˜1.5 molar, more preferable 1.03˜1.2 molar 1,3-propanediol.

Terephthalic acid is fed from the raw material feeding apparatus 1 and is charged into the raw material mixing tank 10. 1,3-propanediol is stored in the raw material feeding apparatus 2 and is charged into the raw material mixing tank 10 by liquid feeding pump 11.

The raw material mixing tank 10 is a tank equipped with mixing means, which mixes liquid glycol and solid powder dicarboxylic acid.

1,3-propanediol and terephthalic acid fed into the raw material mixing tank 10 become a raw material slurry with certain viscosity by mixing with the mixing means.

The raw material mixing tank 10 can be equipped with heating means to obtain the fluidity of prepared raw material slurry. Heating temperature herein is 25˜150 ° C., preferably 50˜100 ° C.

The raw material mixing tank 10 can be fed with modifiers and stabilizers etc. The modifiers are other dicarboxylic acid except terephthalic acid, for example, oxycarboxylic acids like malic acid, tartaric acid and citric acid. Feeding amount of the other dicarboxylic acid is, to amount of terephthalic acid, about 0.075˜0.125 molar %, preferably about 0.1 molar %. The stabilizers are phosphoric stabilizers like phosphoric acid, trimethyl phosphate, triphenyl phosphate etc.

The raw material slurry is prepared in the raw material mixing tank 10 and is fed into the raw material tank 20 by liquid feeding pump 12.

The raw material tank 20 is a tank, which stores temporally the raw material slurry being fed continuously into the reaction system.

Stored raw material slurry can be stirred mechanically with stirring means equipped with mixing impeller to avoid precipitation of suspended terephthalic acid. Besides, circulation line like FIG. 1 can be equipped outside of the raw material tank 20 and the raw material slurry can be continuously circulated at the higher speed of flow than the speed of precipitation of terephthalic acid to avoid the precipitation. Circulation pump 13 generating the circulation is a gear pump, a plunger pump etc. equipped with circulation line.

The raw material tank 20 can be equipped with heating means to obtain fluidity of raw material slurry. Herein, heating temperature is 25˜150° C., preferably 5˜100° C.

The raw material slurry stored in the raw material tank 20 is fed into the esterification reactor 30 by the liquid feeding pump 14.

The esterification reactor 30 makes 1,3-propanediol and terephthalic acid to carry over the dehydration condensation reaction and produces the oligomers of low molecular weight polyester and at the same time is the reactor, which carry out the esterification process volatilizing volatile component including the eliminated water in the dehydration condensation reaction.

The present dehydration condensation reaction is a equilibrium reaction, therefore the reaction is improved, if generated oligomer is removed out from the reactor to outsides and if the eliminated water in the dehydration condensation reaction is volatilized.

The esterification reactor 30 is a heat-resisting and a pressure-resisting reactor, which has at least a inlet of the raw material slurry and a outlet of polymer and a outlet of volatilizing component. The reactor has types of vertical, horizontal and tank-type.

The esterification reactor 30 is equipped with stirring means and heating means. The catalyst feeding apparatus 5, a thermometer, a pressure gauge can be used as well. The stirring means is stirring apparatus, which has paddle type stirring blade, turbine blade, anchor type stirring blade, double-motion type stirring blade, helical ribbon blade etc. Heating means is a jacket-type heat exchanger covering reactor or a tube-type heat exchanger equipped inside and outside of the reactor. These heating means can be used combining plural heat exchanger.

Reaction temperature in the esterification reactor 30 is 180˜220° C., preferably 190˜210° C. If the reaction temperature is lower than 180° C., reaction rate is low and poor in utility. On the other hand, if the reaction temperature is higher than 220° C., there is probability of heat degradation of produced oligomer.

Pressure condition in the esterification reactor 30 is reduced pressure atmosphere, normally 200 Torr (26.7 kPa)˜600 Torr (80.0 kPa). If pressure in the esterification reactor 30 is reduced pressure atmosphere lower than normal atmospheric pressure, volatilization of water is accelerated and water remaining in the reaction system is decreased. Anyway the present reduced pressure atmosphere is made by decompression apparatus 33.

Reaction time in the esterification reactor 30 is 0.5˜2 hours, preferably 0.75˜1.5 hours. Reaction should be carried out until acid value of ester becomes lower than 30, preferably lower than 15, further preferably lower than 10.

Catalyst can be used during the reaction in the esterification reactor 30. As catalyst, for the example, at least one metallic compound selected from the group of Li, Mg, Ca, Ba, La, Ce, Ti, Zr, Hf, V, Mn, Fe, Co, Ir, Ni, Zn Ge or Sn is used. As for metallic compound, metal complex like acetyl acetonate, metal organic salt, organo metallic compound like metal alkoxide, metal oxide, metal hydroxide, metal inorganic salt like metal carbonate salt, metal phosphate salt, metal sulphonate salt, metal nitrate salt, metal chloride salt are pointed out.

As catalyst, Titan compound is preferable among these compounds, titan dioxide or organo titanium compound is further preferable. As for organo titanium compound, for example, titan alkoxide like titan tetra-ethoxide, titan tetra-iso-propoxide, titan tetra-butoxide etc. are pointed out.

Amount of catalyst to the total terephthalic acid is 1000˜8000 ppm, preferably 2000˜4000 ppm.

Oligomer produced in the esterification reactor 30 is fed through the outlet of polymer into first polymerization reactor 40 by the liquid feeding pump 15.

As for the liquid feeding pump 15, canned pump, plunger pump etc. can be used, but preferably gear pump, which is suitable for highly viscous liquid feeding, is used.

Volatile component including volatilized the eliminated water from the esterification reactor 30 is exhausted through the outlet of volatile component into the first condenser 31 by the reduced pressure caused by decompression apparatus 33.

Further, in the esterification reactor 30, terephthalic acid etc. as raw materials can work as acid catalyst to dehydrate 1,3-propanediol to produce toxic acrolein. The boiling point of acrolein is lower than water, therefore produced acrolein is volatilized with eliminated water and is exhausted into the first condenser 31. In addition, scatter inside of the esterification reactor 30 consists of unreacted 1,3-propanediol etc. Such a scatter can be mixed in exhaust system by entrainment with volatilizated eliminated water and can be exhausted into the first condenser 31 together.

The esterification reactor 30 is connected to the exhaust system, which consists of the first condenser 31, the second condenser 32, the decompression apparatus 33 and the detoxifying apparatus 34.

The condenser is an apparatus, which condensates high boiling point component in the gaseous phase, separates it from low boiling point component and exhausts condensated component and noncondensable component.

In the production apparatus of the present embodiment, the exhaust systems are equipped with condensers, which consists of at least two steps, the first condensers 31, 41, 51, 61 and the second condensers 32, 42, 52, 62. The first condensers 31, 41, 51, 61, which are connected directly to reactors, are wet-type condenser, which makes direct heat exchange between volatile component and coolant. Next, the second condensers 32, 42, 52, 62 are indirect heat exchange-type condensers, which make heat exchange without any contacting between inletting volatile component and coolant.

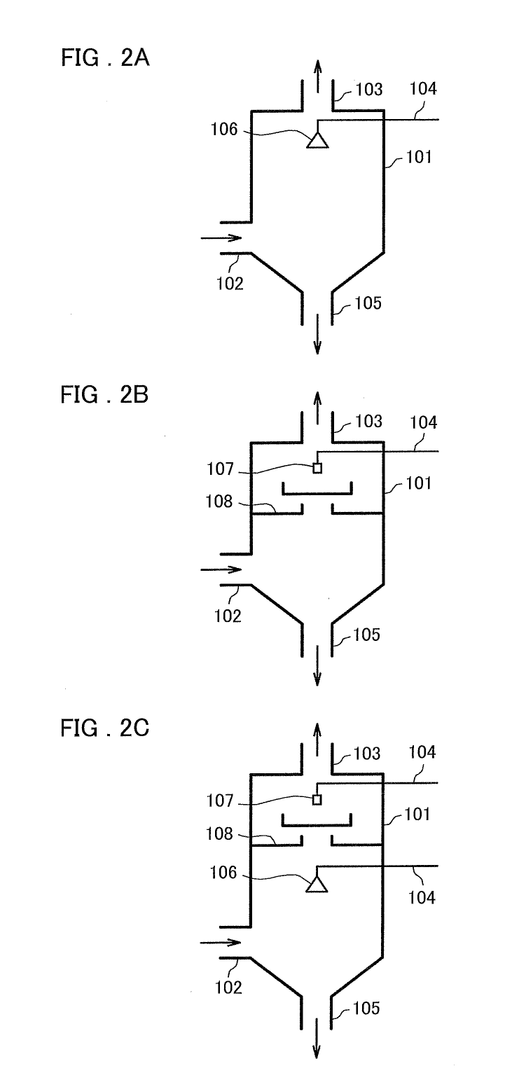

FIG. 2A-2C are schematic drawings showing the form of a wet-type condenser.

FIG. 2A shows the form of shower-type wet-type condenser. FIG. 2B shows the form of a tray-type wet-type condenser. FIG. 2C shows the form of a complex wet-type condenser combined of them.

The wet-type condenser can be any form of FIG. 2A˜2C. A main vessel 101 has at least a volatile component's inlet 102 suctioning a volatile component, and non-condensation component's outlet 103 outletting non-condensation component, and condensed component's outlet 105 outletting condensed component.

The shower-type wet-type condenser has spray nozzle 106, which sprays coolant against volatile component, on the top of coolant feeder 104 feeding coolant.

The tray-type wet-type condenser has a tray 108, which makes gas liquid contact of coolant and volatile component, on the top of coolant feeder 104, and feeding nozzle 107 feeding coolant to the tray 108.

Further, complex wet-type condenser is equipped with the tray 108, which makes gas-liquid contact between coolant and volatile component, and spray nozzle 106 on the top of the coolant feeder 104, in which the coolant flows, and feeding nozzle 107.

As for coolant of wet-type condenser, solution consisting of raw material 1,3-dipropanediol, which can be fed from the raw material feeder 2 by the solution sending pump 18, can be used. Further, the solution sending pump et al. refluxes condensed liquid as coolant from the bottom to the top of the main tank 101

The 1^{st} condenser is wet-type condenser, and its temperature of coolant can be controlled by the heating means 39. Its heating temperature is 20˜100° C. normally lower than the boiling point of 1,3-propanediol, preferably 50˜80° C.

Temperature of coolant is set up higher than the boiling point of acrolein and lower than the boiling points of 1,3-propanediol and water. Then, 1,3-propanediol and the eliminated water, which are included in the volatile component from the esterification reactor 30, can be condensed, and acrolein can be exhausted as non-condensated component.

More 1,3-propanediol can be carried with spray from the esterification reactor 30, which is operated under reduced pressure atmosphere, compared with normal pressure condition. Such large amount of 1,3-propanediol would induce malfunction of pressure reducing device and blocking of pipes. But if the first condenser 31 is wet-type condenser, possibility of such troubles would be lower.

Further, raw material 1,3-propanediol is used as coolant by the wet-type first condenser 31, which can collect 1,3-propanediol included in volatile component and can reduce the loss of raw materials.

Condensed component, which includes condensed water by the first condenser, is discharged from condensed component outlet, then is caught by the catch pot 38, is sent to the hot well 70.

On the other side, non-condensed component is discharged through non-condensed component's outlet to the second condenser 32 by negative pressure caused by pressure reducing device 33

The second condenser 32 is a indirect heat exchanging condenser. Temperature of equipped indirect heat exchanger is set up at the higher temperature than the boiling point of acrolein. Therefore, acrolein stays in gas phase as non-condensed component and other components can be condensed. Condensed components here are, for examples, remaining 1,3-propanediol and circled non reactive ester and others.

Condensed component condensed in the second condenser 32 is discharged from condensed component's outlet through drain 37 to out of the production apparatus. Or it is recharged to the raw material tank 20 and the esterification reactor 30 and is reused as raw materials.

On the other side, non-condensed component containing acrolein, which is separated in the second condenser 32, is introduced through the non-condensed component's outlet into the detoxifying apparatus 34 by negative pressure caused by pressure reducing device 33.

The pressure reducing device 33, which is set up in the pipe of the latter part of the second condenser, is reducing pressure pump, ejector or others, which reduces pressure of reactor's atmospheric set up in reaction system. While the pressure reducing device 33 can reduce the pressure in the reactor of the esterification reactor 30, setup position and connection situation are not problem. That is, it can be connected directly to the first condenser 31, also can be connected indirectly to the second condenser 32. The detoxifying apparatus 34 is the apparatus, which collect and remove toxic component included in the exhausted non-condensed component, and is wet-type and dry-type scrubber using activated carbon as adsorbent. Non-condensed component, which toxic component is removed by the detoxifing apparatus 34, can be discharged out of the production apparatus.

Oligomer, which is sent from the esterification reactor 30 of the reaction system, is consequently fed to the first polymerizing reactor 40.

The first polymerizing reactor 40 is reactor, which makes the polycondensation reaction between oligomers, that is low molecular weight polyester, and increases polymerization degree, and produces prepolymer, that is higher polymerization degree's polyester, and makes a part of polycondensation process, that is improved by volatilization of eliminated component in the polycondensation reaction at the same time.

This polycondensation reaction is a equilibrium reaction, therefore to improve the reaction, produced prepolymers should be discharged out of reactor and eliminated component during the polycondensation reaction should be volatilized.

The first polymerizing reactor 40 is a heat resistance and a pressure resistance reactor, which has at least inlet of polymer, outlet of polymer and outlet of volatile component. The reactor can be vertical type, horizontal type and tank type, preferably vertical type.

The first polymerizing reactor 40 can be equipped with stirring means and heating means, further, catalyst feeding apparatus, thermometer, manometer and others. Stirring means is stirring apparatus, which has Paddle blade, turbine blade, anchor blade, double-motion blade or helical ribbon blade. Heating means is jacket-type heat exchanger, which covers the reactor, or heat pipe-type heat exchanger, which has heat pipe inside of the reactor and outside of the reactor. Combination of heat means can be used.

The reaction temperature of the first polymerizing reactor 40 is 140˜260° C., preferably 150˜250° C. If the reaction temperature is lower than 140° C., the reaction rate is slow and lacks utility. On the other hand, if the reaction temperature becomes higher than 260° C., there is possibility that produced prepolymer decomposes.

The pressure condition of the first polymerizing reactor 40 is reduced pressure to promote volatilization, normally 5 Torr (0.667 kPa)˜200 Torr (26.7 kPa).

The reaction time of the first polymerizing reactor 40 is 1˜4 hours until average polymerization degree becomes about 20˜30.

In the first polymerizing reactor 40, the similar catalyst to the catalyst used in the esterification reactor 30 can be used. Further, if enough catalyst is included in the oligomer fed from the esterification reactor 30, it isn't necessary to add the additional catalyst in this step.

The prepolymer produced by the first polymerizing reactor 40 is fed through polymer outlet to the intermediate polymerization reactor 50 by the feeding pump 16.

As for the feeding pump 16, canned pump, plunger pump etc. can be used. Preferably, gear pump, which is adequate for feeding viscous liquid, can be used.

Further, the volatile component, which includes the product volatilized by the first polymerizing reactor 40, is exhausted through volatile component outlet into the first condenser 41 by the reduced pressure caused by the decompression apparatus 43.

At this time, the produced acrolein is volatilized with the eliminated product, similarly in the the esterification reactor 30, and is exhausted into the first condenser 41. In addition to that, unreacted 1,3-propanediol and relatively low molecular oligomer can fly off in the first polymerizing reactor 40, and can be brought with spray of the eliminated product, which is to be volatilized, to the exhaust system. Such a material is exhausted into the first condenser 41, too.

The intermediate polymerization reactor 50 causes polycondensation reaction between the each prepolymer, which has relatively low polymerization degree, to increase the polymerization degree, and produces polyester of higher polymerization degree. At the same time, the intermediate polymerization reactor 50 is the reactor, which executes a part of polycondensation process volatilizing the eliminated products made in the polycondensation reaction.

The present polycondensation is an equilibrium reaction, therefore, exhausting the produced polyester out of the reactor and volatilization of the eliminated products made in the polycondensation reaction promote the reaction.

The intermediate polymerization reactor 50 is equipped with at least a polymer inlet, a polymer outlet and a volatilized component outlet, and is the heat-resisting and pressure-resisting reactor. The reactor can be vertical or horizontal tank as the embodiment, preferably horizontal type. Further, inside of the reactor can be separated into plural reaction chambers.

The intermediate polymerization reactor 50 is equipped with stirring means and heating means. Further possibly with a thermometer and a pressure gauge. The stirring means is the stirring apparatus, which has lattice wings, wheel wings, glasses wings, hybrid wings, paddle wings, turbine wings, anchor wings, double-motion wings or helical ribbon wings. Preferably twin screw stirrer, which lifts and stirs to make sure of the gas-liquid interface area, and extends and folds high viscous polyester. Further, twin screw stirrer should be arranged so that polymer sticking to the stirrer's screw could be exfoliated. It is better to prevent polymer from staying in the reactor and to avoid excess thermal history. As heating means, the jacket-type heat exchanger, which covers outside of the reactor vessel, or the heat-transfer-pipe type heat exchanger, which can be arranged insides and outsides of the reactor, can be used. These heating means can be used in the combination of plural heat exchanger.

In the intermediate polymerization reactor 50, reaction temperature is 235˜260° C., preferably 240˜255° C. If the reaction temperature is lower than 235° C., reaction rate is slow and it is not practically useful. On the other hand, if the reaction temperature becomes higher than 260° C., produced polyester could decompose thermally.

In the intermediate polymerization reactor 50, pressure condition is highly vacuumed to promote volatilization, 0.5 Torr (0.0667 kPa)˜5 Torr (0.667 kPa), preferably 1 Torr (0.133 kPa)˜2 Torr (0.267 kPa). In the intermediate polymerization reactor 50, reaction time is 0.5˜10 hours, preferably 1˜8 hours, the reaction continues until the average polymerization degree of the produced polymer becomes about 40˜60.

The produced polymer in the intermediate polymerization reactor 50 is fed through polymer outlet into the last polymerization reactor 60 by the feeding pump 17.

As for the feeding pump 17, canned pump, plunger pump etc. can be used, preferably adequate gear pump, which can feed high viscous liquid.

The volatile component volatilizated in the intermediate polymerization reactor 50 is exhausted though volatile component outlet into the first condenser 51 by the reduced pressure caused by the decompression apparatus 53.

At this time, a small amount of produced acrolein is volatilized with the eliminated products and is exhausted into the first condenser 51. In addition to that, unreacted 1,3-propanediol and relatively low molecular oligomer and prepolymer etc. can fly off in the intermediate polymerizing reactor 50, and can be brought with the spray of the eliminated products, which are to be volatilized, to the exhaust system. Such a material is exhausted into the first condenser 51, too.

The last polymerization reactor 60 is the reactor, which carries out polycondensation reaction between each polyester to increase its polymerization degree and executes a part of polycondensation procedure of high polymerization degree polyester adequate for fiber. The last polymerization reactor 60 follows the intermediate polymerizing reactor 50. In the last polymerization reactor 60, eliminated product produced in the polycondensation reaction is volatilized.

In the last polymerization reactor 60, the reaction temperature is 245˜255° C., preferably about 250° C. If the reaction temperature is lower than 245° C., reaction rate is low and it is not practically useful. On the other hand, if the reaction temperature becomes higher than 255° C., produced polyester could decompose thermally.

In the last polymerization reactor 60, pressure condition is highly vacuumed to promote volatilization, 0.5 Torr (0.0667 kPa)˜1.5 Torr (0.200 kPa), preferably about 1 Torr (0.133 kPa).

In the last polymerization reactor 60, reaction time is 0.5˜10 hours, preferably 1˜8 hours, the reaction continues until the average polymerization degree of the produced polymer becomes about more than 80.

Polymer produced in the last polymerization reactor 60 is fed through polymer outlet 90 into a cooling tank to be cooled. Thereafter the cooled polymer is pelletized by chip-cutter and dried to produce trimethylene terephthalate as product.

Further, volatile component, which includes eliminated products volatilized in the last polymerization reactor 60, is exhausted through volatile component outlet into the first condenser 61 by the reduced pressure caused by the decompression apparatus 63.

At this time, similarly to the intermediate polymerization reactor 50, acrolein, unreacted 1,3-propanediol, which is brought with spray of the eliminated products, and relatively low molecular oligomers and prepolymer etc. are exhausted into the first condenser 61.

Each of the first polymerization reactor 40, the intermediate polymerization reactor 50 and the last polymerization reactor 60 is connected to the exhaust system, which consists of the similar components to those of esterification reactor 30. These exhaust systems consist of mainly the first condensers 41, 51, 61, the second condensers 42, 52, 62, decompression apparatus 43, 53, 63 and detoxifying apparatus 44, 54, 64.

The first condensers 41, 51, 61 are wet-type condenser, temperature of coolant is set by heating means 49, 59, 69, for example, higher than the boiling point of acrolein and lower than the boiling points of 1,3-propanediol, relatively low molecular oligomers, prepolymer, polyester etc. Therefore, in each of polymerization reactors 40, 50, 60, 1,3-propanediol included in the exhausted volatile component, eliminated products of relatively low molecular oligomers, prepolymer, polyester, scatter brought with spray of eliminated products to be volatilized are condensed, and are collected by catch-pots 48, 58, 68, and are fed to the hot-well 70.

On the other hand, acrolein and other non-condensable component are exhausted to each of the second condensers 42, 52, 62.

The condensed components including a small amount of 1,3-propanediol condensed by the second condensers 42, 52, 62 are exhausted from the drain 47, 57, 67 to out of the production apparatus, or is fed again to the raw material reserving tank 6 and the esterification reactor 9, used as raw materials.

The second condensers 52, 62 are installed in the exhaust system of the intermediate polymerization reactor 50 and the last polymerization reactor 60, and are wet-type condensers. The condensed liquid, which includes 1,3-propanediol circulated from bottom of the second condensers 52, 62 to the top of the second condensers 52, 62 by the pumps 55, 65, works as coolant. A part of condensed liquid, which is not exhausted from the drains 57, 67, is heated by the heating means 56, 66, is fed again to the top of the second condensers 52, 62.

On the other hand, non-condensed component, which includes acrolein separated by the second condensers 42, 52, 62, is fed into detoxifying apparatus 44, 54, 64 by the reduced pressure caused by the decompression apparatus 43, 53, 63, and is exhausted out of the production apparatus after its toxic component is removed.

The hot well 70 is a vessel, which reserves the condensed component condensed by the condenser. The hot well 70 can collect 1,3-propanediol eliminated in the polycondensation reaction, the eliminated product of relatively low molecular oligomers, prepolymer and polyester etc., scatter etc., which is brought with spray of eliminated product to be volatilized.

The hot well 70 consists of tank type vessel or store type vessel, which has at least condensate liquid inlet and reserving liquid outlet.

The hot well 70 can be equipped with at least one of stirring means and heating means. The stirring means are stirring apparatus, which are equipped with puddle blade, turbine blade, anchor blade, double-motion blade or helical ribbon blade. The heating means is jacket-type heat exchanger covering the reactor vessel or tube-type heat exchanger equipped inside and outside of the reactor. These heating means can be used combining plural heat exchanger.

In the hot well 70, condensate liquid, which includes eliminated product recovered from the first condensers 41, 51, 61, can be hydrolyzed by the eliminated water, which is condensed by the first condenser 31, as a result, hydrolysis liquid can be obtained. In such a manner, relatively low molecular oligomer, prepolymer, polyester and non-reactive circle polyester are hydrolyzed into 1,3-propanediol, relatively low molecular straight chain-type oligomer, prepolymer and polyester, at the same time, the water condensed by the first condenser 31 is consumed. Further, if the water condensed by the first condenser 31 is not enough for hydrolysis, water can be supplied from the outsides of the production apparatus through the water supplying pipe 72. Moreover, if the hot well 70 is driven at high temperature, evaporating water and 1,3-propanediol etc. can be cooled and returned to the hot well 70 by possible reflux condenser 75.

The heating temperature in the hot well 70 is 20˜200° C., preferably about 50˜150° C.

The pressure condition in the hot well 70 is about 1 Torr (0.133 kPa)˜760 Torr (101 kPa), preferably about 100 Torr (13.3 kPa)˜760 Torr (101 kPa). If the pressure is higher than 1 Torr (0.133 kPa), stored 1,3-propanediol and oligomer are prevented from volatilizing.

The stored liquid, which includes condensed liquid collected by the hot well 70, can be refluxed through the stored liquid outlet to the raw material tank 20 or to the esterification reactor 30.

The hydrolyzed liquid can be fed again to the raw material tank 20 and to the esterification reactor 30 to be used again in reaction system, So raw material yield can be increased.

Further, the hot well 70 collects the coolant used in the first condensers 31, 41, 51, 61, which are wet-type condenser. Therefore the coolant can be refluxed to the reaction system and can be used as raw materials.

Furthermore, acrolein produced by dehydration of 1,3-propanediol is a small amount. Therefore, the condensed liquid collected by the hot well 70 can be directly refluxed to the reaction system without multi distillation column etc. through only the hot well 70, which can be installed at low cost.

The stored liquid, which includes condensed liquid collected by the hot well 70, can be fed through the stored liquid outlet into the hot well 72, which heats the stored liquid

The hot well 72 as well as the hot well 70 consists of tank-type vessel or pool-type vessel, which has at least the condensed liquid inlet and the stored liquid outlet, and heating means, which heats and evaporates the water included in the stored liquid.

If the condensed liquid collected by the hot well 70 and the hydrolyzed liquid produced by hydrolysis in the hot well 70 has a large amount of water, the water should be heated and evaporated in the hot well 72, then the condensed liquid and the hydrolyzed liquid, which water is removed, should be returned to the raw material tank 20 or esterification reactor 30 to carry out dehydration condensation reaction. The water of the condensed liquid and the hydrolysis liquid is evaporated and removed, then the amount of water, which refluxes to the reaction system, decreases, and can avoid deactivation of catalyst and reducing reaction rate of the esterification reaction

Further, if acrolein is included by the collected condensed liquid, the condenser 74 can separate it from the condensed liquid, and non-condensed component, which includes acrolein, is introduced into the detoxification apparatus 77 by the reduced pressure caused by the decompression apparatus 76 and is later exhausted out of the production apparatus. Further, condensed component separated by the condenser 74 can be refluxed, for example, to the hot well 70.

In such a production apparatus of the present embodiment, the esterification reactor 30, which is driven under reduced pressure, executes the esterification process, and the water, which is produced by the dehydration condensation reaction, can be removed smoothly from reaction system. In addition to that, the esterification process can be improved and the production of heat decomposition is inhibited and higher amount of catalyst is not necessary. Therefore, high quality polyester can be produced.

Further, executing the esterification process under reduced pressure makes scatter of 1,3-propanediol etc. increase comparing with under normal pressure. But the first condenser 31 of wet-type condenser can surely collect the scatter. Therefore, trouble of the decompression apparatus of exhaust systems and pipe blockade etc. caused by scatter can be decreasing and running cost can be reduced. Further, 1,3-propanediol etc. included in the scatter can be efficiently used again and raw material yield can be increased.

As mentioned above, the apparatus of the present embodiment is explained, but the present invention is not limited, but can be changed, for example, as following.

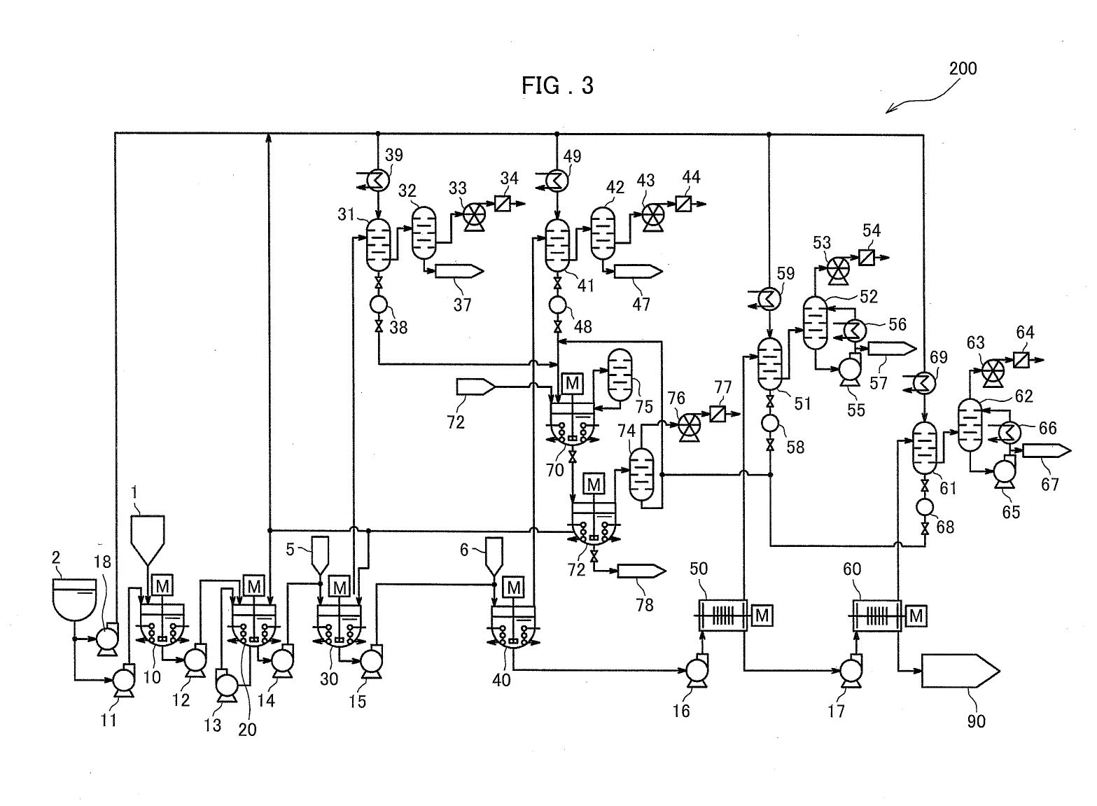

FIG. 3 shows the outline structure of the first modification of the production apparatus 200.

As written before, in the embodiment of production apparatus 100, the first condensers, 31, 41, 51, 61 of wet-type condenser mainly uses as coolant the solution, which includes 1,3-propanediol, which is directly fed as raw material by the feeding pump 18.

However, as shown in the FIG. 3, the condensed liquid collected by the hot wells 70, 72 and the hydrolyzed liquid obtained by the hot well 70 can be used as coolant of the first condensers 31, 41, 51, 61. In such a way, 1,3-propanediol etc., which flies off from reaction system and is mixed into the exhaust system, can be used efficiently. Further, temperature of condensed liquid and the hydrolyzed liquid as coolant can be controlled by heating means 39, 49, 59, 69. Coolant can be heated by the hot wells 70, 72 and thereafter can be fed to the wet-type condenser, so heating cost by heating means 39, 49, 59, 69 can be decreased.

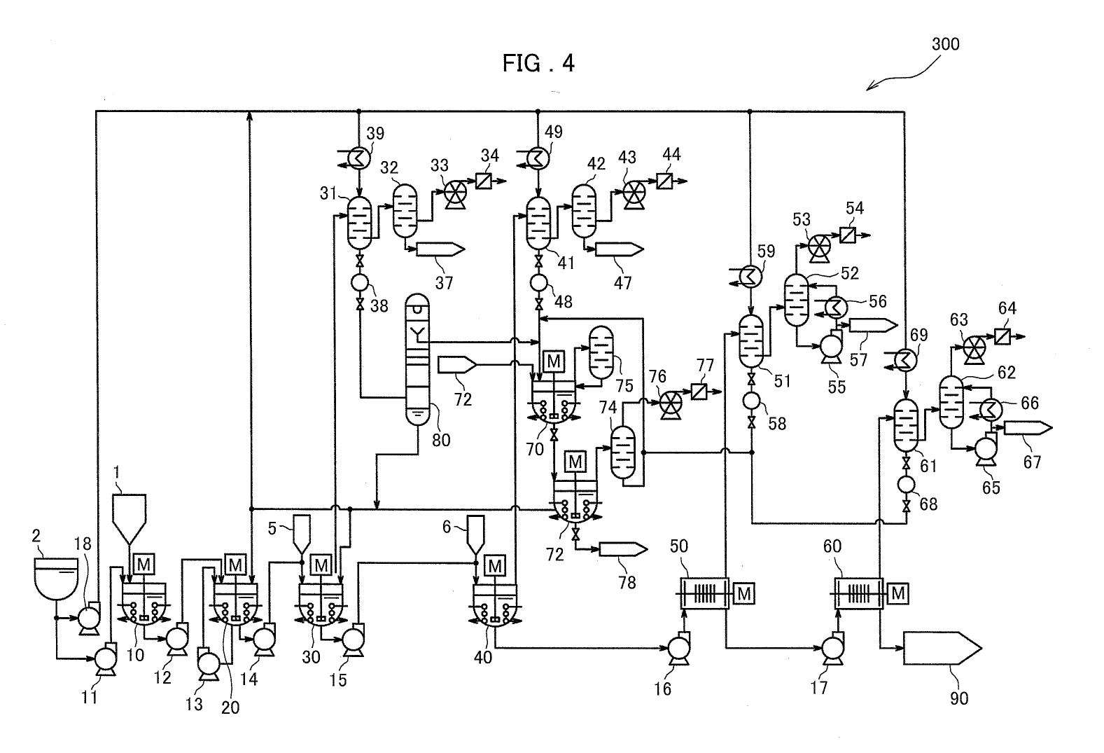

FIG. 4 shows outline structure of the second modification of the production apparatus 300.

In the production apparatus 100 of embodiment written before, the condensed component outlet of the first condenser 31 is directly connected to the hot well 70.

However, as shown by FIG. 4, the distillation column 80 can be installed between the condensed component outlet and the hot well 70. Water is distilled from the top of the column 80 and fed through the condenser 74 to the hot well 70. 1,3-propanediol is distilled from the bottom of the column and is directly returned to the raw material tank 20 or to the esterification reactor 30. By these manner, the water volatilyed from the reaction system and scatter of 1,3-propanediol etc. mixed into the exhaust system can be distillated fractionally at high degree of purification. The water refluxing into the reaction system can be removed and the effect of water to the reaction system can be decreased. In addition to that, 1,3-propanediol etc. included in scatter can be purified and be used again in the reaction system. As a result, raw material yield can increase.

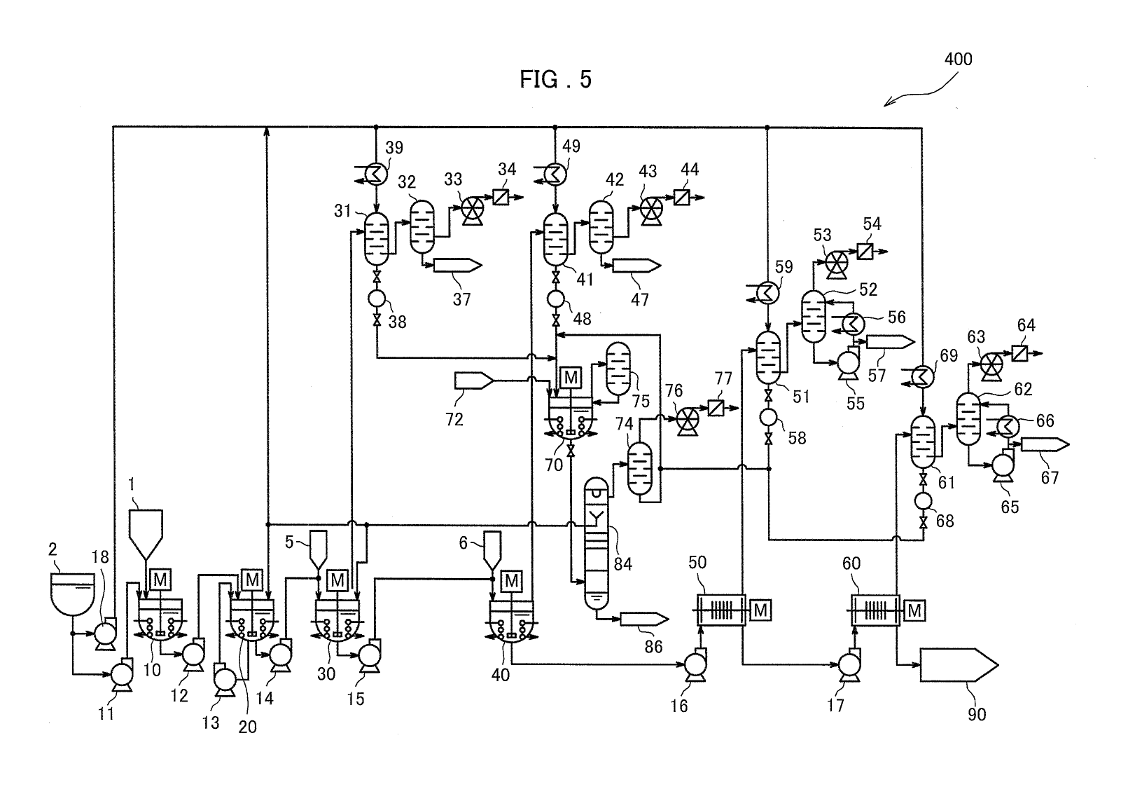

FIG. 5 shows outline structure of the third modification of the production apparatus 400.

In the production apparatus 100 of embodiment written before, the hot well 72, which is equipped with the heating means, is installed between the condensed component outlet of the first condenser 31 and hot well 70.

However, as shown by FIG. 5, the distilling column 84 instead of the hot well 72 can be installed next to the hot well 70. Water can be distilled from the top of the distillation column 84 and is returned to the hot well 70. 1,3-propanediol can be distilled from the intermediate part of the column and can be returned to the raw material tank 20 or to the esterification reactor 30. The water used in the process of hydrolysis in the hot well 70, 1,3-propanediol collected in the exhaust system, hydrolyzed and relatively low molecular straight chain oligomer, prepolymer and polyester etc. can be distilled fractionally at high purification degree. Effect of water in the reaction system can be decreased. In addition to that, the eliminated product, which is collected in the exhaust system, can be used again as raw material. Further, in the bottom of column, fraction of oligomer, prepolymer, polyester etc., which are not able to be hydrolyzed, can be obtained, and exhausted component from drain 86 can be used again.

### EMBODIMENT

Next the present invention is concretely explained, showing the embodiment. However, the present invention is not limited such a embodiment.

As a embodiment, in the production apparatus of the present embodiment, the esterification reactor 30 is driven under reduced pressure, and polytrimethylene terephthalate is produced.

Terephthalic acid as raw material is fed by the raw material feeding apparatus 1 to the raw material mixing tank 10, and 1,3-propanediol is fed to the raw material mixing tank 10 at the ratio 1.3 mole to 1 mole terephthalic acid, and both are mixed at 80° C. to prepare raw material slurry.

In esterification reactor 30, 3000 ppm titan tetrabutoxide is added to the raw material slurry, and the esterification reaction is carried out at 205° C., under 400 Torr (53.3 kPa) for 4 hours to produce oligomer.

Next, in the first polymerization reactor 40 the polycondensation reaction of oligomer is made at 250° C., under 20 Torr (2.67 kPa) for an hour to produce the prepolymer.

In the intermediate polymerization reactor 50, prepolymer's polycondensation reaction is made at stirring rate 3 rpm, at 250° C., 2 Torr (0.267 kPa) for 3 hours. In the last polymerization reactor 60, the polycondensation reaction is made at stirring rate 1 rpm, at 250° C., under 1 Torr (0.133 kPa) to produce polytrimethylene terephthalate.

Further in the exhaust system, which is connected to the first polymerization reactor 40, intermediate polymerization reactor 50 and the last polymerization reactor 60, the coolant's temperature of wet-type condenser and the first condensers 41, 51, 61 are 80° C. to condense volatile component. In hot well 70, heating temperature is 200° C., residence time is 5 min. to carry out hydrolysis of condensed eliminated products. Thereafter, in hot well 42, heating temperature is 110° C., pressure is 400 Torr (53.3 kPa), residence time is 5 min. to remove remaining water after hydrolysis to reflux to the esterification reactor 30.

In the last polymerization reactor 60, the polycondensation reaction continues for 2 hours to produce polytrimethylene terephthalate, which has weight average molecular weight about 80000 and 75% yield.

As comparative example, in the production apparatus of the present embodiment, the esterification reactor 30 works under normal pressure to produce polytrimethylene terephthalate.

In the comparative example, pressure of the esterification reactor 30 is changed to normal pressure, and other conditions are the same as embodiments described above.

In the last polymerization reactor 60, 6 hours' polycondensation reaction produces polytrimethylene terephthalate, which has weight average molecular weight about 50000 and 70% yield. Compared with the embodiment, the production efficiency becomes lower.

### Clarification of Numbers

100 polyester production apparatus

1, 2 raw material feeder

5, 6 catalyst feeder

10 raw material mixing tank

20 raw material tank

11, 12, 13, 14, 15, 16, 17, 18, 55, 65 liquid feeding pump

30 esterification reactor

31, 41, 51, 61 the first condenser (wet-type condenser)

32, 42, 52, 62 the second condenser

33, 43, 53, 63, 76 decompression apparatus

34, 44, 54, 64, 77 detoxifying apparatus

37, 47, 57, 67, 78, 86 drain

38, 48, 58, 68 catch-pot

39, 49, 56, 59, 66, 69 heating means

40 the first polymerization reactor (polymerization reactor)

50 the mediate polymerization reactor (polymerization reactor)

60 the last polymerization reactor (polymerization reactor)

70, 74 hot well

72 water feeding pipe

74 condenser

75 reflux condenser

79 valve

80, 84 distillation column

90 polymer outlet

101 container body

102 volatile component inlet

103 non-condensed component outlet

104 coolant feeding pipe

105 condensed component outlet

106 spray nozzle

107 supplying nozzle

108 distillation tray

What is claimed is:

1. A polyester production apparatus comprising:
an esterfication reactor which produces polymer from 1,3-propanediol and a dicarboxylic acid by a dehydration condensation reaction, and volatilizes a volatile component including eliminated water produced by said dehydration condensation reaction,
a plurality of polymerizing reactors which increase a polymerization degree by facilitating a polycondensation reaction between the polymers, and volatilizes the volatile component including the eliminated product produced by said polycondensation reaction,
a wet-type condenser which condenses said eliminated water by contacting a coolant containing 1,3-propanediol thereto, and respectively exhausts the condensed component and non-condensed component, and
a decompression apparatus which reduces a pressure in said esterification reactor, whereon
an outlet of the volatile component included in said esterification reactor is connected to an inlet of the volatile component included in said wet-type condenser, and
said decompression apparatus is connected to a poststage side of an outlet of the non-condensed component included in the wet-type condenser.

2. The polyester production apparatus described in claim 1, wherein further the apparatus comprising:
the wet-type condenser which condenses said eliminated product by conducting with the coolant including 1,3-propanediol, and exhausts the condensed component and the non-condensed component, and
a hot well in which a hydrolysis liquid of said condensed component is stored,
wherein the said wet-type condenser is connected to said polymerization reactor, and
the outlet of condensed component of the wet-type condenser is connected to said hot well.

3. The polyester production apparatus as described in claim 1, wherein further
the hot well in which the hydrolysis liquid of said condensed component is stored, wherein the outlet of the condensed component of the wet-type condenser is connected to said hot well.

4. The polyester production apparatus as described in claim 2, wherein outlet of said condensed component of the said wet-type condenser which condenses eliminated water is connected to said hot well.

5. The polyester production apparatus as described in claims 2, wherein the outlet of the stored liquid of said hot well is connected to said esterification reactor.

6. The polyester production apparatus as described in claim 5, wherein the heating means warming said hydrolysis liquid is installed between said outlet of the stored liquid of said hot well and the said esterification reactor.

7. The polyester production apparatus as described in claims 1, the said wet-type condenser is equipped with the heating means, which warms said coolant.

8. The polyester production apparatus as described in claims 1, wherein polytrimethylene terephthalate is produced.

9. A polyester production method comprising the steps of:
a esterification step of carrying out an dehydration condensation reaction esterifying 1,3-propanediol and a dicarboxylic acid under a pressure of 26.7 kPa˜80.0 kPa to produce polymer, to volatilize a volatile component including eliminated water to be produced in said dehydration condensation reaction, and
a polycondensation step which increases a polymerization degree by carrying out a polycondensation reaction between polymers, and volatilizes volatile component including an eliminated product generated in said polycondensation reaction.

10. The polyester production method as described in claim 9, wherein further comprising the steps of:
a condensing step which condenses the said eliminated water volatilized and the said eliminated product volatilized, and
a step obtaining hydrolysis liquid by hydrolyzing the said eliminated product condensed with the said eliminated water condensed.

11. The polyester production method as described in claim 10, wherein further comprising the step of:
a step, evaporating the water included in said hydrolysis liquid.

12. The polyester production method as described in claim 11, wherein further comprising the step of:
a step producing polymer by the dehydration condensation reaction between said hydrolysis liquid after evaporation of the water and dicarboxylic acid.

13. The polyester production method as described in claims 9, wherein polytrimethylene terephtalate is produced.
